(19) United States
(12) Patent Application Publication
(10) Pub. No.: US 2023/0300887 A1
(43) Pub. Date: Sep. 21, 2023

(54) TERMINAL AND BASE STATION

(71) Applicant: NTT DOCOMO, INC., Tokyo (JP)

(72) Inventors: Daisuke Kurita, Tokyo (JP); Shinya Kumagai, Tokyo (JP); Hiroki Harada, Tokyo (JP); Jing Wang, Beijing, (CN); Xiaolin Hou, Beijing, (CN); Liu Liu, Beijing, (CN); Junli Li, Beijing, (CN); Yong Li, Beijing, (CN)

(73) Assignee: NTT DOCOMO, INC., Tokyo (JP)

(21) Appl. No.: 18/006,036

(22) PCT Filed: Jul. 30, 2020
(86) PCT No.: PCT/JP2020/029303

§ 371 Date: Jan. 19, 2023

(51) Int. Cl. H04W 74/08; H04W 72/0453

(52) U.S. Cl. CPC H04W 74/0833; H04W 74/0816; H04W 72/0453

(57) ABSTRACT

A terminal (UE 200) receives a temporary identifier and offset information in an initial access channel when using a second frequency band different from a first frequency band allocated for mobile communication. Also, the terminal (UE 200) converts the received temporary identifier into an identifier for communication in the second frequency band based on the offset information.

### TECHNICAL FIELD

The present invention relates to a terminal and a base station that perform radio communication, and more particularly relates to a terminal and a base station that use unlicensed frequency bands.

### BACKGROUND ART

3rd Generation Partnership Project (3GPP) specifies Long Term Evolution (LTE), and is also proceeding with specifications of LTE-Advanced (hereinafter, the LTE includes the LTE-Advanced) with the aim of further accelerating in the LTE, and furthermore, specifications of 5th generation mobile communication systems (also called 5G, New Radio (NR) or Next Generation (NG)).

For example, for NR, similar to LTE, New Radio-Unlicensed (NR-U) is being considered, which uses the spectrum of unlicensed (no license) frequency bands to expand the available frequency bands (Non-Patent Literature 1).

In the NR-U, the Listen-Before-Talk (LBT) mechanism is also applied, which allows a radio base station (gNB) to transmit a radio signal within a predetermined time length only when the radio base station has performed carrier sensing and confirmed that the channel is not being used by other nearby systems before starting transmitting the radio signal in the unlicensed frequency band.

In such a case, the terminal (User Equipment, UE) may fail the RA in a random access (RA) procedure as a result of congestion, LBT failure, etc. due to contention with other terminals for the uplink resource allocated from the gNB.

Therefore, it is planned to allocate a plurality of uplink resources to the UE performing the RA procedure (Random Access procedure) (Non-Patent Literature 2, 3).

### CITATION LIST

### Non-Patent Literature

Non-Patent Literature 1: 3GPP TR 38.889 V 16.0.0, 3rd Generation Partnership Project; Technical Specification Group Radio Access Network; Study on NR-based access to unlicensed spectrum (Release 16), 3GPP, December 2018 Non-Patent Literature 2: HARQ enhancement for NR-U, R1-1910461, 3GPP TSG-RAN WG1 Meeting #98bis, 3GPP, October 2019

Non-Patent Literature 3: Remaining Issues for NR-U, R1-1910464, 3GPP TSG RAN WG1 #98bis, 3GPP, October 2019

### SUMMARY OF THE INVENTION

However, even in the case of allocating a plurality of uplink resources, since the gNB responds only to the first UE receiving the message among the plurality of UEs, there is a problem that the other UEs are highly likely to fail the RA, resulting in a delay of the random access (RA).

Therefore, the present invention has been made in view of this situation. An object of the present invention is to provide a terminal and a base station capable of increasing the probability of success of the random access (RA) and suppressing delay when allocating a plurality of uplink resources in the random access (RA) procedure of an NR-U using an unlicensed frequency band.

An embodiment of the present disclosure is a terminal (UE 200) comprising: a reception unit (radio signal transmission and reception unit 210) that receives a temporary identifier (TC-RNTI: Temporary Cell-Radio Network Temporary Identifier) and offset information in an initial access channel (RACH: Random Access CHannel) when using a second frequency band (unlicensed frequency band Fu) different from a first frequency band allocated for mobile communication; and a control unit (control unit 270) that converts the temporary identifier received by the reception unit into an identifier (C-RNTI: Cell-Radio Network Temporary Identifier) for communication in the second frequency band based on the offset information.

Another embodiment of the present disclosure is a base station (gNB 100) comprising: a control unit (control unit 150) that derives a temporary identifier (TC-RNTI) and offset information for converting the temporary identifier (TC-RNTI) into an identifier (C-RNTI) for communication in a second frequency band (unlicensed frequency band Fu) different from a first frequency band allocated for mobile communication; and a transmission unit (radio transmission unit 110) that transmits the temporary identifier (TC-RNTI) and the offset information when using the second frequency band.

### BRIEF DESCRIPTION OF DRAWINGS

FIG. 1 is an overall schematic diagram of a radio communication system 10.

FIG. 2 shows an example of a functional block configuration of the UE 200.

FIG. 3 is a diagram showing the relationship among a temporary identifier (for example, TC-RNTI), offset information, and an identifier (for example, C-RNTI) for communication in an unlicensed frequency band Fu.

FIG. 4 shows an example of the functional block configuration of the gNB 100.

FIG. 5 shows an example of an RA failure scenario in an NR-U.

FIG. 6 shows an example in which a plurality of uplink resources are allocated for Msg. 3.

FIG. 7 is a diagram showing an example of an RA problem that occurs when a plurality of UEs transmit in a plurality of resources for Msg. 3 in the NR-U.

FIG. 8 is a diagram showing an operation example 1 regarding the offset information notification procedure.

FIG. 9 shows the relationship among UE ID transmitted in Msg. 3, offset A/B/C notified in advance, and UE Contention Resolution Identity MAC CE received in Msg. 4.

FIG. 10. shows an example of an offset notification method in the two-step RA procedure from Msg. A to Msg. B.

FIG. 11 shows an example of a hardware configuration of the UE 200 and/or the gNB 100.

### DESCRIPTION OF EMBODIMENTS

Embodiments will be described below with reference to the drawings. Note that, the same functions and configurations are designated by the same or similar reference numerals, and the description thereof will be appropriately omitted.

### (1) Overall Schematic Configuration of Radio Communication System

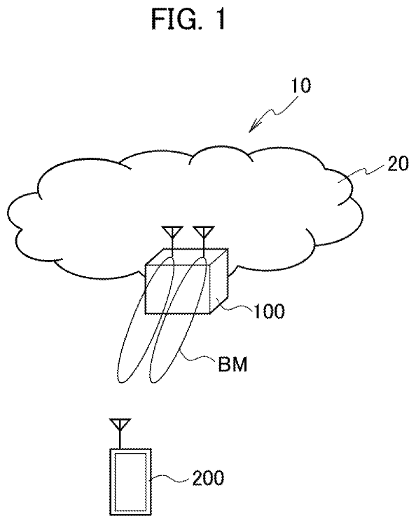

FIG. 1 is an overall schematic configuration diagram of a radio communication system 10 according to the present embodiment. The radio communication system 10 is a 5G New Radio (NR) compliant radio communication system and includes a Next Generation-Radio Access Network 20 (hereinafter NG-RAN 20), and a terminal 200 (hereinafter, UE 200).

The NG-RAN 20 includes a radio base station 100 (hereinafter, gNB 100). The specific configuration of the radio communication system 10 including the number of gNBs and UEs is not limited to the example shown in FIG. 1.

The NG-RAN 20 actually includes a plurality of NG-RAN Nodes, specifically gNBs (or ng-eNBs), and is connected to a 5G-compliant core network (5GC, not shown). The NG-RAN 20 and 5GC may be simply expressed as a “network”.

The gNB 100 is a radio base station according to 5G, and executes radio communication according to the UE 200 and 5G. The gNB 100 and the UE 200 can support Massive MIMO (Multiple-Input Multiple-Output) that generates a beam BM with higher directivity by controlling radio signals transmitted from a plurality of antenna elements, Carrier Aggregation (CA) that bundles and uses a plurality of component carriers (CCs), Dual Connectivity (DC) that simultaneously performs communication between a UE and each of two NG-RAN Nodes, Integrated Access and Backhaul (IAB) that integrates a radio backhaul between radio communication nodes such as the gNBs and radio access to the UE, and the like.

The radio communication system 10 supports a plurality of frequency ranges (FRs).

In addition, in the radio communication system 10, in addition to a frequency band (first frequency band) allocated for the radio communication system 10, an unlicensed frequency band (hereinafter, it may be referred to as “Fu”.) (second frequency band) different from the frequency band is used. Specifically, in the radio communication system 10, New Radio-Unlicensed (NR-U) is practicable which expands available frequency bands by using a spectrum of unlicensed (no license) frequency bands.

The frequency band allocated for the radio communication system 10 is the frequency band included in the frequency range and based on the license allocation by the administration.

The unlicensed frequency band Fu is a frequency band that does not need to be allocated a license by the administration and can be used without being limited to a specific telecommunications carrier. For example, a frequency band (2.4 GHz or 5 GHz band, etc.) for a wireless LAN (WLAN) can be cited.

In the unlicensed frequency band Fu, it is possible to install a radio station without being limited to a specific telecommunications carrier, but it is not desirable that signals from nearby radio stations interfere with each other to greatly deteriorate communication performance.

Therefore, for example, in Japan, as a requirement for a radio system using the unlicensed frequency band Fu (for example, 5 GHz band), the mechanism of Listen-Before-Talk (LBT) that allows transmission within a predetermined time length is applied only when the gNB 100 performs carrier sensing before starting transmitting and it is confirmed that the channel is not being used by other nearby systems. Carrier sensing is a technique for confirming whether the frequency carrier is not used for other communications before transmitting a radio wave.

The gNB 100 performs carrier sensing and when it is confirmed that the channel is not being used by other nearby systems, transmits a radio link monitoring reference signal, specifically, a radio link monitoring-reference signal (RLM-RS), toward the inside of the forming cell.

The UE 200 is also provided with one or more Physical Random Access Channels (PRACH) transmission occasions associated with an SSB (SS/PBCH Block) including a synchronization signal (SS) and a downlink physical broadcast channel (PBCH).

In the present embodiment, the following four-step RA procedure is basically performed. That is, first, the UE 200 transmits the preamble to the gNB 100 in the RACH procedure (step 1). The gNB 100 receiving the preamble transmits information regarding resource for allowing next transmission (for example, TC-RNTI) as an RA response to the UE 200 (step 2). Then, the UE 200 transmits information such as terminal identification information (UE ID) to the gNB 100 using the TC-RNTI in the allowed resource based on the received information or the like (step 3). Finally, the gNB 100 transmits information identifying the C-RNTI (in the present embodiment, it is not the C-RNTI itself, but offset information for converting the TC-RNTI into the C-RNTI, etc.) (step 4). That is, TC-RNTI is a temporary RNTI used in the RACH procedure, and C-RNTI is an RNTI used exclusively for the UE after the RACH procedure.

### (2) Function Block Configuration of Radio Communication System

The functional block configuration of the radio communication system 10 will be described below.

### (2.1) UE 200

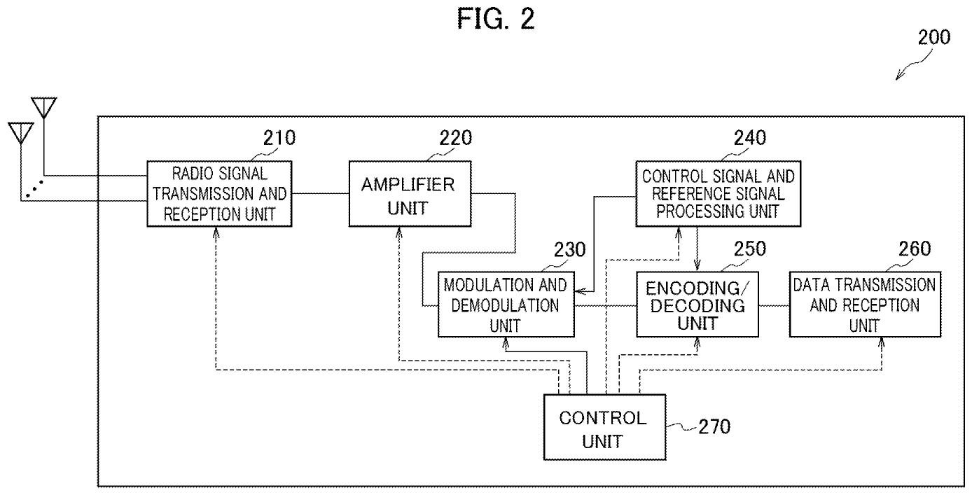

First, a functional block configuration of the UE 200 will be described. FIG. 2 shows an example of a functional block configuration of the UE 200. As shown in FIG. 2, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260 and a control unit 270.

The radio signal transmission and reception unit 210 transmits and receives radio signals in accordance with NR. The radio signal transmission and reception unit 210 supports Massive MIMO, CA that bundles and uses a plurality of CCs, and DC that simultaneously performs communication between the UE and each of the two NG-RAN Nodes, and the like.

In the present embodiment, when using an unlicensed frequency band Fu (second frequency band) different from a frequency band (first frequency band) allocated for the radio communication system 10, the radio signal transmission and reception unit 210 receives a temporary identifier (TC-RNTI, etc.) and offset information in an initial access channel (RACH). Here, the radio signal transmission and reception unit 210 may receive downlink control information (for example, DCI: Downlink Control Information) including the offset information. The radio signal transmission and reception unit 210 may also receive collision avoidance information (for example, MAC CE: Media Access Control Control Element that notifies UE Contention Resolution Identity) including the offset information. The radio signal transmission and reception unit 210 may also receive collision avoidance information taking the offset information into account.

The amplifier unit 220 includes a PA (Power Amplifier)/LNA (Low Noise Amplifier) or the like. The amplifier unit 220 amplifies a signal output from the modulation and demodulation unit 230 to a predetermined power level. The amplifier unit 220 also amplifies an RF signal output from the radio signal transmission and reception unit 210.

The modulation and demodulation unit 230 executes data modulation/demodulation, transmission power setting, resource block allocation, and the like for each predetermined communication destination (gNB 100 or another gNB).

The control signal and reference signal processing unit 240 executes processing regarding various control signals transmitted and received by the UE 200 and processing regarding various reference signals transmitted and received by the UE 200.

Specifically, the control signal and reference signal processing unit 240 receives various control signals transmitted from the gNB 100 via a predetermined control channel, for example, a control signal of the radio resource control layer (RRC). In addition, the control signal and reference signal processing unit 240 transmits various control signals to the gNB 100 via a predetermined control channel.

The control signal and reference signal processing unit 240 executes processing using a reference signal (RS) such as a demodulation reference signal (DMRS) and a phase tracking reference signal (PTRS). The DMRS is a reference signal (pilot signal) known between a terminal-specific base station and a terminal for estimating a fading channel used for data demodulation. The PTRS is a terminal-specific reference signal for the purpose of estimating phase noise, which is a problem in a high frequency band. The reference signal includes a Channel State Information-Reference Signal (CSI-RS) and a Sounding Reference Signal (SRS) in addition to DMRS and PTRS. Further, the reference signal includes RLM-RS as described above.

Further, the channel includes a control channel and a data channel. The control channel includes PDCCH (Physical Downlink Control Channel), PUCCH (Physical Uplink Control Channel), PRACH (Physical Random Access Channel), PBCH (Physical Broadcast Channel), and the like. The data channel includes PDSCH (Physical Downlink Shared Channel), PUSCH (Physical Uplink Shared Channel), and the like.

The encoding/decoding unit 250 executes data division/connection, channel coding/decoding, and the like for each predetermined communication destination (gNB 100 or another gNB).

Specifically, the encoding/decoding unit 250 divides data output from the data transmission and reception unit 260 into a predetermined size, and executes channel coding on the divided data. Also, the encoding/decoding unit 250 decodes the data output from the modulation and demodulation unit 230 and connects the decoded data.

The data transmission and reception unit 260 executes transmission and reception of Protocol Data Unit (PDU) and Service Data Unit (SDU). Specifically, the data transmission and reception unit 260 executes assembly/disassembly or the like of PDU/SDU in a plurality of layers (media access control layer (MAC), radio link control layer (RLC), and packet data convergence protocol layer (PDCP), etc.). Also, the data transmission and reception unit 260 executes data error correction and retransmission control based on the hybrid ARQ (Hybrid automatic repeat request).

The control unit 270 controls each functional block configuring the UE 200. In particular, in the present embodiment, the control unit 270 executes control regarding the NR-U.

Specifically, the control unit 270 executes an initial access to the network in the unlicensed frequency band Fu. That is, the control unit 270 executes a random access (RA) procedure in conjunction with the control signal and reference signal processing unit 240.

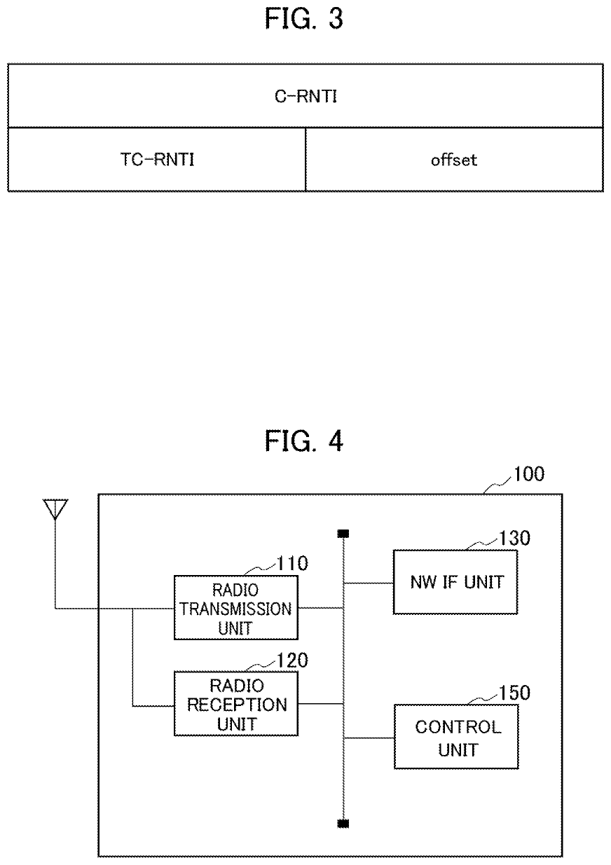

In such a case, the control unit 270 converts a temporary identifier (for example, TC-RNTI) into an identifier (for example, C-RNTI) for communicating in the unlicensed frequency band Fu (second frequency band) based on the offset information. Here, FIG. 3 is a diagram showing the relationship among the temporary identifier (for example, TC-RNTI), the offset information, and the identifier (for example, C-RNTI) for communicating in the unlicensed frequency band Fu. As shown in FIG. 3, by way of example, the control unit 270 can calculate the C-RNTI by adding the offset value to the TC-RNTI.

Here, the control unit 270 may further determine whether the offset information and/or the identifier is directed to itself (the UE 200). For example, the control unit 270 may determine whether the received collision avoidance information (for example, UE Contention Resolution Identity MAC CE) takes into account the offset information predetermined in the specifications, etc. or received separately through MIB (Master Information Block)/SIB (System Information Block), etc.

The control unit 270 also receives the random access response from the network and completes the initial access (random access).

### (2.2) gNB 100

Next, a functional block configuration of the gNB 100 will be described. Here, FIG. 4 is a diagram showing an example of the functional block configuration of the gNB 100. As shown in FIG. 4, the gNB 100 includes a radio transmission unit 110, a radio reception unit 120, an NW IF unit 130, and a control unit 150.

The radio transmission unit 110 transmits radio signals in accordance with 5G specifications. The radio reception unit 120 transmits radio signals in accordance with 5G specifications. In the present embodiment, the radio transmission unit 110 and the radio reception unit 120 execute radio communication with the UE 200 or the like.

In the present embodiment, when using an unlicensed frequency band Fu (second frequency band), the radio transmission unit 110 transmits a temporary identifier and offset information in an initial access channel (RACH). Here, the radio transmission unit 110 may transmit downlink control information (for example, DCI) including the offset information. The radio transmission unit 110 may also transmit collision avoidance information (for example, Contention Resolution Identity MAC CE) including the offset information. The radio transmission unit 110 may also transmit collision avoidance information (for example, UE Contention Resolution Identity MAC CE) taking the offset information into account.

The NW IF unit 130 provides a communication interface for enabling connection with the NGC side or the like. For example, the NW IF unit 130 may include interfaces such as X2, Xn, N2, N3, etc.

The control unit 150 executes control of each functional block configuring the gNB 100. In particular, in the present embodiment, the control unit 150 executes control regarding the NR-U.

For example, when using the unlicensed frequency band Fu (second frequency band), the control unit 150 derives a temporary identifier (such as TC-RNTI) and offset information. Here, the control unit 150 may generate downlink control information (for example, DCI) including the offset information. The control unit 150 may also generate collision avoidance information (for example, UE Contention Resolution Identity MAC CE) including or taking into account the offset information. The information taking into account the offset information is intended not to be information of the offset information itself, but is intended to be information obtained by mixing the offset information with other information. For example, the offset information and the other information may be added, subtracted, multiplied, divided, and the offset information and the other information may be scrambled. As a more specific example, the control unit 150 may generate UE Contention Resolution Identity MAC CE (=UE ID+A/B/C . . . ) by adding its UE ID (e.g.: core network identification) and offset A/B/C . . . (values predetermined in the specifications or values broadcast in the MIB/SIB, etc.). The control unit 150 issues the offset information in consideration of the fact that the corresponding identifier (such as C-RNTI) can be allocated.

### (3) Operation of Radio Communication System

Next, the operation of the radio communication system 10 will be described. Specifically, the operation regarding an initial access of the terminal (UE 200) and the base station (gNB 100) using the LBT in the RACH procedure in the NR-U will be described.

### (3.1) Operation Overview

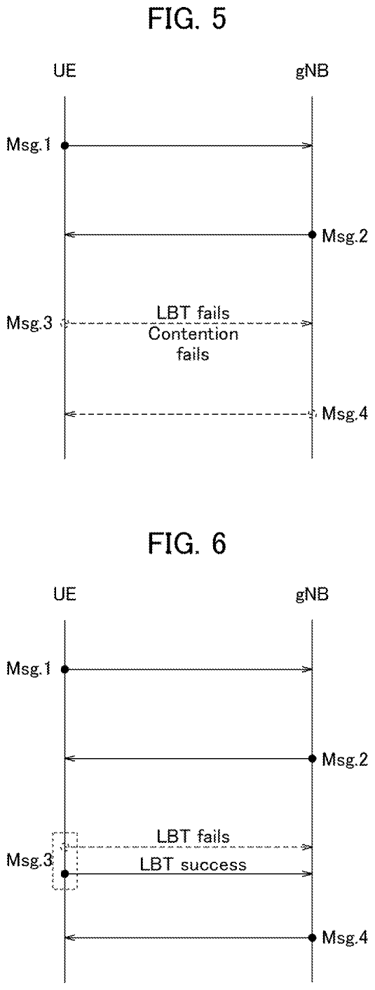

In the case of the NR-U, in the RA procedure, a terminal (User Equipment, UE) may fail RA as a result of congestion, failure of LBT, etc. due to contention with other terminals for uplink resources allocated from the gNB. Here, FIG. 5 is a diagram showing an example of an RA failure scenario in the NR-U.

As shown in FIG. 5, first, the UE transmits Msg. 1 to the gNB in the RA procedure.

Next, the gNB receiving Msg. 1 transmits a response, and transmits Msg. 2 to the UE in order to allocate uplink resources.

Then, The UE detecting the channel status before transmitting Msg. 3 may be unable to transmit Msg. 3 with the allocated uplink resources and may fail in random reception when congestion, failure of LBT, etc. occur due to contention with other terminals for the uplink resource allocated from the gNB. As described above, in the NR-U system, a failure may occur in the random access of the UE due to LBT failure or the like.

Therefore, it is planned to allocate a plurality of uplink resources for Msg. 3 to the UE performing the RA procedure (Non-Patent Literature 2, 3). Here, FIG. 6 is a diagram showing an example in which a plurality of uplink resources for Msg. 3 are allocated.

As shown in FIG. 6, the gNB receiving Msg. 1 as described above transmits a response, and transmits Msg. 2 to the UE in order to allocate a plurality of uplink resources and TC-RNTI.

Then, the UE to which a plurality of uplink resources are allocated, as shown in FIG. 6, has a high possibility of succeeding in LBT and transmitting Msg. 3 at the second transmission opportunity (TxOP: transition opportunity), even if the first LBT transmission fails due to channel congestion at the time of channel status detection before Msg. 3 transmission.

Subsequently, the gNB receiving Msg. 3 transmits Msg. 4 as a collision avoidance message (contention resolution message) to the UE.

Finally, the UE uses the TC-RNTI for addressing to compare whether the core network identifier in Msg. 4 is the same as the core network identifier in Msg. 3. If they are the same case, the random access is successful.

However, even in the case of allocating a plurality of uplink resources for Msg. 3 as described above, since the gNB responds only to the first UE receiving the message among the plurality of UEs, there is a problem that other subsequent UEs are highly likely to fail RA, resulting in RA delay.

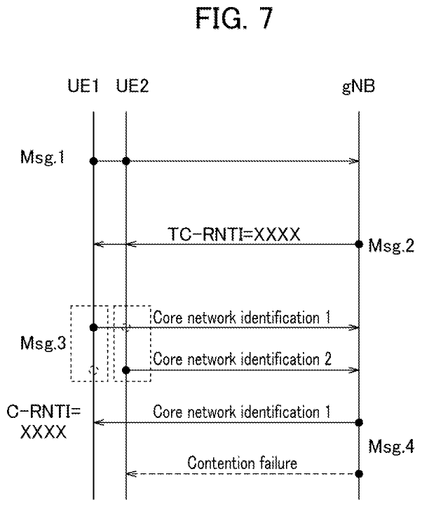

That is, if a plurality of uplink resources for Msg. 3 are introduced, although a plurality of UEs can respond to the same Msg. 2 by using different Msg. 3 resources, in order to avoid allocating the same TC-RNTI as the C-RNTI to a plurality of UEs, the gNB responds only to the first received Msg. 3 in the random access period and transmits the corresponding Msg. 4. Therefore, since subsequent Msg. 3 transmitted from other UEs are not answered to, other UEs may still fail access within the RA period. Here, FIG. 7 is a diagram showing an example of an RA problem that occurs when a plurality of UEs transmit with a plurality of resources for Msg. 3 in the NR-U. Note that if a plurality of UEs are in the CONNECTED or INACTIVE state from the beginning, this problem does not exist because each UE already has an allocated C-RNTI.

As shown in FIG. 7, when UE1 and UE2 in the idle state select to transmit the same preamble using the same time-frequency resource at the initial access, they receive the same RA response message Msg. 2 and acquire the same temporary identifier TC-RNTI.

UE1 and UE2 that have acquired the same TC-RNTI, according to their respective LBT results, can respond to the same Msg. 2 at different timings using a plurality of resources for Msg. 3.

However, the gNB responds only to the first received Msg. 3 from the UE1 in the RA period and transmits Msg. 4. Therefore, Msg. 3 transmitted from the UE2 is not answered to, and the UE2 results in access failure in this random access period.

As described above, the UE is provided with a plurality of transmission resources for Msg. 3 transmission, but if one UE transmits Msg. 3 first, the other UEs cannot receive Msg. 4 anymore and fail random access. Therefore, there is still room for improvement to increase the possibility of RA success. Note that, in the above, if the gNB is simply to respond to a plurality of Msg. 3 from a plurality of UEs, it would be problematic because a plurality of UEs upgrade the TC-RNTI to the same as the C-RNTI.

Therefore, in the present embodiment, we have made an ingenious idea by adding the offset information so that the TC-RNTI that can be duplicated between UEs can be converted into the C-RNTI that is not duplicated. More specifically, in the RACH procedure, the conversion method from TC-RNTI to C-RNTI is extended to separately notify the offset value when converting TC-RNTI to C-RNTI. An operation example of a specific offset notification method will be described below.

### (3.2) Operation Example

Next, an operation example of the terminal (UE 200) and the base station (gNB 100) in the case where a plurality of uplink resources are applied to the above-described UE will be described.

In this operation example, in the NR-U, offset information for the temporary identifier TC-RNTI is notified from the network or the like to the terminal. That is, the UE does not upgrade to obtain the C-RNTI directly according to the TC-RNTI shown in Msg. 2, but upgrades to the C-RNTI by combining identify offset indication, which is offset information added newly in Msg. 4, with the TC-RNTI. Thus, a plurality of UEs are enabled to perform random access in the same random access period and access delay is reduced while avoiding the problem that a plurality of UEs have the same TC-RNTI, which occurs when directly upgrading the TC-RNTI.

### (3.2.1) Operation Example 1

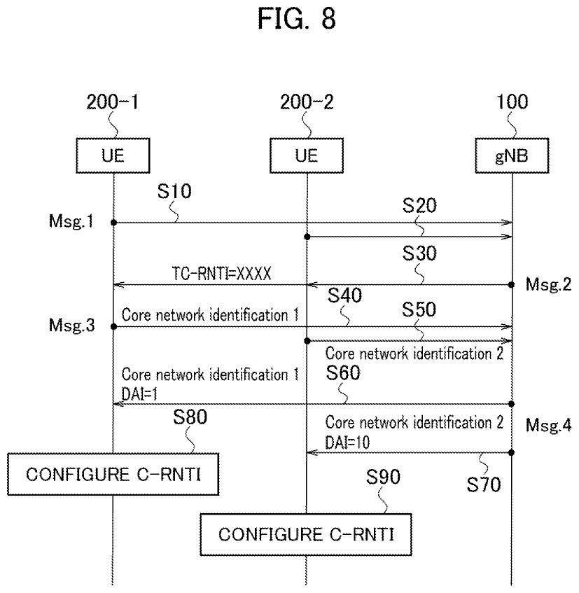

In this operation example 1, offset information is notified by using a bit for notifying DAI (Downlink Assignment Index) of DCI (Downlink Control Information). FIG. 8 is a diagram showing the operation example 1 regarding the notification procedure of offset information.

As shown in FIG. 8, it is assumed that the UEs 200-1 and 200-2 in the idle state transmit the same preamble using the same time-frequency resource at the time of initial access (S10, S20).

Then, since the gNB 100 transmits the same RA response message Msg. 2 containing the same TC-RNTI, the UE 200-1 and the UE 200-2 acquire the same temporary identifier TC-RNTI based on the received same Msg. 2 (S30).

Then, the UE 200-1 and the UE 200-2 which have acquired the same TC-RNTI, according to their respective LBT results, transmit Msg. 3 responding to the same Msg. 2 to the gNB 100 at different timings by using a plurality of resources for Msg. 3 (S40, S50). Each core network identifier is allocated to Msg. 3.

Subsequently, the gNB 100 transmits to each of the UEs 200-1, 2 Msg. 4 including separate offset information associated with their respective core network identifiers (S60, S70). That is, the gNB 100 transmits offset information (in this example, DAI=1) including the core network identifier 1 to the UE 200-1 that has transmitted Msg. 3 including the core network identifier 1 (S60), and transmits offset information (in this example, DAI=10) including the core network identifier 2 to the UE 200-1 that has transmitted Msg. 3 including the core network identifier 2 (S70).

As described above, in this operation example 1, the offset information is notified by using the bit for notifying the DAI of the DCI. That is, in this operation example 1, the DAI is used as the identity offset indication, and the offset value based on the first allocated TC-RNTI is shown in the DAI. For example, DAI 01 indicates C-RNTI=TC-RNTI+X, and DAI 10 indicates C-RNTI=TC-RNTI+2X. Note that X may be predetermined in the specifications or the like, or may be broadcast from the network by MIB/SIB. The offset information may be information for obtaining the offset value (in this example, DAI information for determining the offset value X when DAI=1 and the offset value 2X when DAI=10, etc.) or the offset value itself. In TS 38.321, TC-RNTI and C-RNTI can take a value in the range of 0001-FFF2 (16 decimal). Therefore, TC-RNTI and C-RNTI are determined within the range of the possible values, and the offset information (the offset value itself may be used.) for obtaining the difference (offset value) between them is also determined. Note that, as long as TC-RNTI and C-RNTI are within an allowable range, the offset value is not limited to the difference between them, but may be a ratio between them. In this case, the C-RNTI can be obtained by dividing or multiplying the TC-RNTI by the offset value (that is, the ratio) obtained from the offset information.

The UEs 200-1, 2 convert the TC-RNTI into the C-RNTI based on the offset information of Msg. 4 received by each (S80, S90). More specifically, the UE 200-1 which has received the offset information (in this example, DAI=1) including the core network identifier 1 converts the TC-RNTI into the C-RNTI (=TC-RNTI+X) based on the offset DAI=1 and sets up communication (S80). On the other hand, the UE 200-2 which has received the offset information (in this example, DAI=10) including the core network identifier 2 converts the TC-RNTI into the C-RNTI (=TC-RNTI+2X) based on the offset DAI=10 and sets up communication (S90).

Thus, since different identity offset values are provided to each of the UEs 200-1, 2 (since different DAIs are provided in this example), a plurality of UEs can generate and use different C-RNTIs between different UEs to perform accurate addressing even if the TC-RNTIs are the same.

In the above communication setting (S80, S90), the UE 200 may confirm whether the network identifiers match. That is, the UE 200-1 may determine whether the network identifier 1 transmitted in Msg. 3 matches the one contained in the received Msg. 4, and the UE 200-2 may determine whether the network identifier 2 transmitted in Msg. 3 matches the one contained in the received Msg. 4. If they do not match, it means that Msg. 4 is not directed to itself and the RA fails. On the other hand, if they match, it means that Msg. 4 is directed to itself, so RA is successful, and communication setting of the NR-U is completed.

As described above, in the operation example 1, the DAI display bit set aside in the DCI transmitting the control signaling in Msg. 4 is set as the identity offset indication. Thus, when a plurality of UEs transmitting different Msg. 3 receive Msg. 4, individual DAIs can be set, so that the UEs can obtain different C-RNTI after collision avoidance.

### (3.2.2) Operation Example 2

Next, operation example 2 will be described as another example of the offset information notification method. Note that, since the flow of Msg. 1 to Msg. 4 is the same as the above, FIG. 8 will be diverted to explain mainly the part that differs from the above while omitting duplicated explanations.

In this operation example 2, the gNB 100 transmits Msg. 4 notifying the offset information by using a new MAC CE (S60, S70). That is, in this operation example 2, the offset information is notified together with the MAC CE notifying the collision avoidance identifier (Contention Resolution Identity). Therefore, the offset information is defined to be transmitted together with UE Contention Resolution Identity (collision avoidance identifier) MAC CE as a new LCID (Logical Channel ID) of the new MAC CE. Note that, the transmitted offset information may be the offset value itself or information for obtaining the offset value (for example, DAI for obtaining the offset value X when DAI=1; the offset value 2X when DAI=10, etc.).

As a result, since the new MAC CE indicates the offset based on the TC-RNTI, the UE 200-1, 2 that has received Msg. 4 can apply the offset+TC-RNTI indicated by the new MAC CE to the C-RNTI after the collision avoidance (contention resolution) (S80, S90).

### (3.3.3) Operation Example 3

Next, operation example 3 will be described as another example of the offset information notification method. Since the flow of Msg. 1 to Msg. 4 is the same as the above in this operation example 3, FIG. 8 will be diverted to explain mainly the part that differs from the above while omitting duplicated explanations.

In this operation example 3, it is assumed that the offset information is notified to the UE 200 and/or the gNB 100 in advance by the specifications or by using the MIB/SIB from the network (not shown).

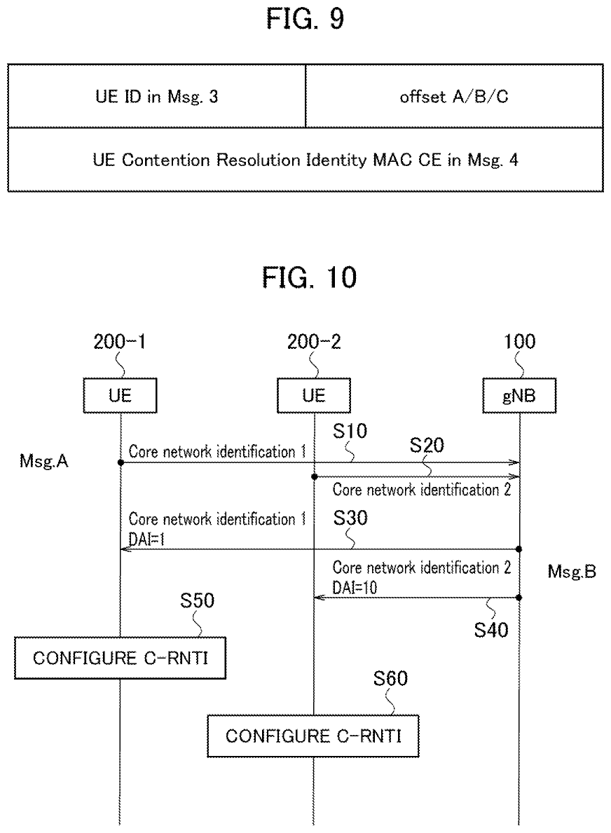

Then, the gNB 100 transmits the collision avoidance information taking the offset information into account as Msg. 4 to the UEs 200-1, 2, instead of transmitting the collision avoidance information including the offset information as Msg. 4 as in the operation example 2 (S60, S70). More specifically, the control unit 150 of the gNB 100 generates UE Contention Resolution Identity MAC CE (that is, as will be described later with reference to FIG. 9, the value obtained by UE Contention Resolution Identity MAC CE=received UE ID+A/B/C . . . ) obtained by adding the UE ID (e.g.: core network identification) received in Msg. 3 and the offset A/B/C . . . (values predetermined in the specifications or broadcast by MIB/SIB), and the radio transmission unit 110 of the gNB 100 transmits the UE Contention Resolution Identity MAC CE as Msg. 4 to the UE 200-1, 2 (S60, S70).

The UE 200-1, 2 that have received Msg. 4 first compares the received UE Contention Resolution Identity MAC CE with the UE ID transmitted in Msg. 3. Here, FIG. 9 is a diagram showing the relationship among the UE ID transmitted in Msg. 3, the offset A/B/C notified in advance, and the UE Contention Resolution Identity MAC CE received in Msg. 4.

As shown in FIG. 9, if the UE Contention Resolution Identity MAC CE received in Msg. 4 is the UE ID transmitted in Msg. 3 plus the offset A/B/C . . . (if UE Contention Resolution Identity MAC CE=transmitted UE ID+A/B/C . . . ), the UE 200-1, 2 assumes that the collision has been successfully avoided and configures the C-RNTI (=TC-RNTI+a/b/c . . . ) (S80, S90). This means that the UE is confirming not only whether the UE Contention Resolution Identity MAC CE in Msg. 4 matches the UE ID transmitted in Msg. 3, but also whether the offset (difference) between the two matches the predetermined/notified value. Note that the relationship between A/B/C and a/b/c (for example, a=A, a=A*X, a=f (A), and so on(f is a function.)) may be predetermined in the specifications or may be broadcast by MIB/SIB. Also, the relationship among A, B, and C (for example, C=3*A; B=2*A) may also be predetermined in the specifications or may broadcast MIB/SIB.

As described above in the operation examples 1 to 3, in the present embodiment, the gNB changes the contents of the conventional Msg. 4 to present an offset value for identifying the UE in addition to the identifier (core network identifier, etc.) of the corresponding UE. Therefore, the UE that has successfully received Msg. 4 can generate its own C-RNTI by adding the offset value of Msg. 4 to the allocated TC-RNTI instead of directly upgrading from the conventional TC-RNTI.

Note that, in the above-described embodiment, although the description has been made by taking the four-step RA procedure from Msg. 1 to Msg. 4 as an example, not limited thereto, the above-described offset notification method may be applied to the two-step RA procedure from Msg. A to Msg. B as shown in FIG. 10.

### (4) Action and Effect

According to the embodiment described above, the following effects are obtained. Specifically, when using an unlicensed frequency band Fu (second frequency band, which may be referred to as an unlicensed band) different from a frequency band (first frequency band) allocated for mobile communication, that is, a licensed frequency band, the UE 200 receives a temporary identifier (TC-RNTI) and offset information in an initial access channel (RACH), and can convert the received temporary identifier into an identifier for communication in the unlicensed frequency band Fu based on the offset information.

Therefore, when allocating a plurality of uplink resources to a plurality of UEs performing the NR-U RA procedure, the plurality of UEs can use the offset information to convert a temporary identifier (TC-RNTI) that may be duplicated into a UE-specific identifier (C-RNTI), thereby further enhancing the resource utilization efficiency of the unlicensed frequency band Fu. That is, since the possibility that a plurality of UEs can simultaneously complete random access in the same RA period can be increased, the RA delay of the plurality of UEs in the unlicensed frequency band Fu can be reduced.

In addition, in the present embodiment, the UE 200 can receive downlink control information (DCI) including offset information. The UE 200 can also receive collision avoidance information (Contention Resolution Identity MAC CE) including offset information.

Therefore, the UE 200 can surely acquire offset information through control information such as DCI and MAC CE.

Further, in the present embodiment, the UE 200 can receive the collision avoidance information (Contention Resolution Identity MAC CE) taking the offset information into account, and determine whether the collision avoidance information takes the offset information that is predetermined or separately received into account.

Therefore, the UE 200 can confirm that the information is transmitted to itself by confirming that the offset information specified in advance/notified is taken into account.

Further, the gNB 100 can derive a temporary identifier (TC-RNTI), and offset information for converting into an identifier (C-RNTI) for communication in the unlicensed frequency band Fu (second frequency band), and transmit the temporary identifier (TC-RNTI) and the offset information when using the unlicensed frequency band Fu.

Therefore, when allocating a plurality of uplink resources to a plurality of UEs performing the RA procedure in the NR-U, the plurality of UEs can use the offset information to convert a temporary identifier (TC-RNTI) that may be duplicated into a UE-specific identifier (C-RNTI), thereby further enhancing the resource utilization efficiency of the unlicensed frequency band Fu. That is, since the possibility that a plurality of UEs can simultaneously complete random access in the same RA period can be increased, the RA delay of the plurality of UEs in the unlicensed frequency band Fu can be reduced.

### (5) Other Embodiments

Although the contents of the present invention have been described in accordance with the embodiments, the present invention is not limited to these descriptions, and it is obvious to those skilled in the art that various modifications and improvements are possible.

For example, unlicensed frequency bands may be referred to by different names. For example, the terms such as License-exempt or Licensed-Assisted Access (LAA) may be used.

The block diagram (FIG. 2, FIG. 4) used in the description of the above-described embodiment shows blocks in units of functions. Those functional blocks (components) can be realized by a desired combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as explained above, the realization method is not particularly limited.

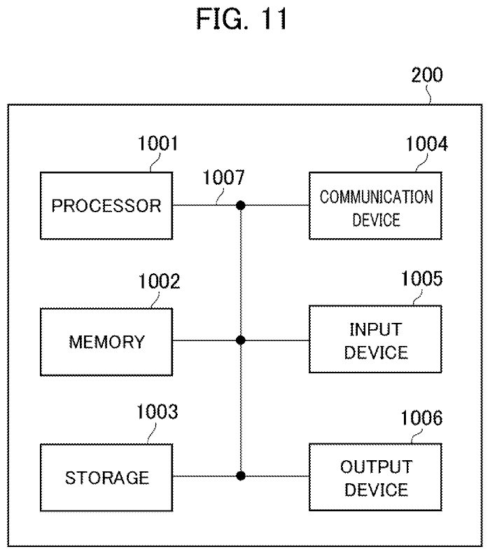

Further, the UE 200 and/or the gNB 100 described above may function as a computer that performs the processing of the radio communication method of the present disclosure. FIG. 11 is a diagram showing an example of a hardware configuration of the UE 200 and/or the gNB 100. As shown in FIG. 11, the UE 200 and/or the gNB 100 may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. The hardware configuration of the device can be constituted by including one or plurality of the devices shown in the figure, or can be constituted without including a part of the devices.

The functional blocks of the UE 200 and the gNB 100 (See FIG. 2 and FIG. 4) are implemented by any of hardware elements of the computer device or a combination of the hardware elements.

Moreover, each function of the UE 200 and the gNB 100 is realized by loading predetermined software (programs) on hardware such as the processor 1001 and the memory 1002 so that the processor 1001 performs arithmetic operations to control communication via communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and may be configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Also, the respective devices such as the processor 1001 and the memory 1002 are connected to each other with the bus 1007 for communicating information therebetween. The bus 1007 may be constituted by a single bus or may be constituted by different buses for each device-to-device.

Further, the device may be configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Further, notification of information is not limited to that in the aspect/embodiment described in the present disclosure, and may be performed by using other methods. For example, the notification of information may be performed by physical layer signaling (for example, Downlink Control Information (DCI), Uplink Control Information (UCI), higher layer signaling (for example, RRC signaling, Medium Access Control (MAC) signaling, broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each of the aspects/embodiments described in the present disclosure can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G) and applied.

The order of processing procedures, sequences, flowcharts, and the like of each of the aspects/embodiments described in the present disclosure may be exchanged as long as there is no contradiction. For example, the methods described in the present disclosure present the elements of the various steps using an exemplary order and are not limited to the presented specific order.

The specific operation that is performed by the base station in the present disclosure may be performed by its upper node in some cases. In a network constituted by one or more network nodes having a base station, it is obvious that the various operations performed for communication with the terminal can be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from a higher layer (or lower layer) to a lower layer (or higher layer). These may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by truth-value (Boolean: true or false), or by comparison of numerical values (for example, comparison with a predetermined value).

Each of the aspects/embodiments described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Regardless of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when software is transmitted from a website, a server, or another remote source by using at least one of a wired technology (coaxial cable, optical fiber cable, twisted pair, Digital Subscriber Line (DSL), or the like) and a wireless technology (infrared light, microwave, or the like), then at least one of these wired and wireless technologies is included within the definition of the transmission medium.

Information, signals, or the like described in the present invention may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in the present disclosure and terms necessary for understanding the present disclosure may be replaced with terms having the same or similar meanings. For example, at least one of a channel and a symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like described in the present disclosure can be represented by an absolute value, can be represented by a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier” can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of at least one of a base station and a base station subsystem that performs communication service in this coverage.

In the present disclosure, the terms such as “mobile station (Mobile Station: MS)”, “user terminal”, “user equipment (User Equipment: UE)”, “terminal” can be used interchangeably.

The mobile station may be called a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), an unmanned moving body (a drone, an automatically driven vehicle, or the like), or a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration in which communication between a base station and a mobile station is replaced with communication between a plurality of mobile stations (for example, it may be called Device-to-Device (D2D), Vehicle-to-Everything (V2X), or the like). In this case, the mobile station may have the function of the base station. In addition, words such as “uplink” and “downlink” may also be replaced with words corresponding to inter-terminal communication (for example, “side”). For example, an uplink channel, a downlink channel, or the like may be read as a side channel.

Similarly, the mobile station in the present disclosure may be read as a base station. In this case, the base station may have the function of the mobile station. A radio frame may be composed of one or more frames in the time domain. Each of one or more frames in the time domain may be referred to as a subframe.

The subframe may be further composed of one or more slots in the time domain. The subframe may be a fixed time length (for example, 1 ms) that does not depend on the numerology.

The numerology may be a communication parameter applied to at least one of transmission and reception of a signal or channel. The numerology may indicate, for example, at least one of subcarrier spacing (SubCarrier Spacing: SCS), bandwidth, symbol length, cyclic prefix length, transmission time interval (TTI), the number of symbols per TTI, radio frame configuration, a specific filtering process performed by a transceiver in the frequency domain, a specific windowing process performed by the transceiver in the time domain, and the like.

The slot may be composed of one or more symbols (Orthogonal Frequency Division Multiplexing (OFDM)) symbols, Single Carrier Frequency Division Multiple Access (SC-FDMA) symbols, etc.) in the time domain. The slot may be a time unit based on the numerology.

The slot may include a plurality of minislots. Each minislot may be composed of one or more symbols in the time domain. A minislot may be called a subslot. The minislot may be composed of fewer number of symbols than the slots. PDSCH (or PUSCH) transmitted in a time unit larger than the minislot may be referred to as PDSCH (or PUSCH) mapping type A. The PDSCH (or PUSCH) transmitted using a minislot may be referred to as PDSCH (or PUSCH) mapping type B.

The radio frame, subframe, slot, minislot, and symbol all represent a time unit for transmitting a signal. The radio frame, subframe, slot, minislot, and symbol may have respectively different names corresponding to them.

For example, one subframe may be called a transmission time interval (TTI), a plurality of consecutive subframes may be called TTI, and one slot or one minislot may be called TTI. That is, at least one of the subframe and TTI may be a subframe (1 ms) in existing LTE, a period shorter than 1 ms (for example, 1 to 13 symbols), or a period longer than 1 ms. Note that, the unit representing TTI may be called a slot, a minislot, or the like instead of a subframe.

Here, TTI refers to the minimum time unit of scheduling in radio communication, for example. For example, in the LTE system, the base station performs scheduling for allocating radio resources (frequency bandwidth that can be used in each user terminal, transmission power, etc.) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When a TTI is given, the time interval (for example, the number of symbols) in which the transport block, code block, codeword, etc. are actually mapped may be shorter than TTI.

When one slot or one minislot is called TTI, one or more TTIs (that is, one or more slots or one or more minislots) may be the minimum time unit for scheduling. Also, the number of slots (the number of minislots) forming the minimum time unit of the scheduling may be controlled.

The TTI having a time length of 1 ms may be referred to as a usual TTI (TTI in LTE Rel. 8-12), a normal TTI, a long TTI, a usual subframe, normal subframe, a long subframe, a slot, or the like. The TTI shorter than the usual TTI may be referred to as a shortened TTI, a short TTI, a partial TTI (partial or fractional TTI), a shortened subframe, a short subframe, a minislot, a subslot, a slot, or the like.

Note that a long TTI (for example, usual TTI, subframe, etc.) may be read as a TTI having a time length exceeding 1 ms, and a short TTI (for example, shortened TTI, etc.) may be read as a TTI having a TTI length of less than the TTI length of the long TTI and a TTI length of 1 ms or more.

The resource block (RB) is a resource allocation unit in the time domain and the frequency domain, and may include one or more continuous subcarriers in the frequency domain. The number of subcarriers included in RB may be the same regardless of the numerology, and may be twelve for example. The number of subcarriers included in the RB may be determined based on the neurology.

Also, the time domain of RB may include one or more symbols, and may be a one slot, one minislot, one subframe, or one TTI in length. Each of one TTI, one subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, and the like.

Further, the resource block may be composed of one or more resource elements (Resource Element: RE). For example, one RE may be a radio resource domain of one subcarrier and one symbol.

A bandwidth part (BWP) (which may be called a partial bandwidth, etc.) may represent a subset of contiguous common RBs (common resource blocks) for certain numerology in a certain carrier. Here, the common RB may be specified by an index of the RB based on the common reference point of the carrier. The PRB may be defined in the BWP and numbered within the BWP.

The BWP may include a BWP for UL (UL BWP) and a BWP for DL (DL BWP). One or more BWPs may be set within one carrier for the UE.

At least one of the configured BWPs may be active, and the UE may not be assumed to transmit and receive a predetermined signal/channel outside the active BWP. Note that “cell”, “carrier”, and the like in the present disclosure may be read as “BWP”.

The structures such as a radio frame, a subframe, a slot, a minislot, and a symbol, etc. described above are merely examples. For example, the configuration such as the number of subframes included in a radio frame, the number of slots per subframe or radio frame, the number of minislots included in a slot, the number of symbols and RBs included in a slot or a minislot, the number of subcarriers included in the RB, and the number of symbols included in the TTI, the symbol length, the cyclic prefix (CP) length, and the like can be changed in various manner.

The terms “connected”, “coupled”, or any variations thereof mean any direct or indirect connection or coupling between two or more elements. Also, one or more intermediate elements are present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using at least one of one or more wires, cables, printed electrical connections, and as some non-limiting and non-exhaustive examples, by using electromagnetic energy having wavelengths in the radio frequency domain, the microwave region and light (both visible and invisible) regions, and the like.

The reference signal may be abbreviated as Reference Signal (RS) and may be called pilot according to applicable standards.

As used in the present disclosure, the phrase “based on” does not mean “based only on” unless explicitly stated otherwise. In other words, the phrase “based on” means both “based only on” and “based at least on”.

The “means” in the configuration of each of the above devices may be replaced with “unit”, “circuit”, “device”, or the like.

Any reference to an element using a designation such as “first”, “second”, and the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

The terms “determining” used in the present disclosure may encompass a wide variety of actions. “Determining” can include that for example, judging, calculating, computing, processing, deriving, investigating, searching (looking up, search, inquiry) (e.g., searching in a table, a database, or another data structure), ascertaining are considered as “determining”, and the like. In addition, “determining” can include that receiving (for example, receiving information), transmitting (for example, transmitting information), input, output, and accessing (for example, accessing data in a memory) are considered as “determining”, and the like. In addition, “determining” can include that resolving, selecting, choosing, establishing, and comparing, and the like are considered as “determining”. That is, “determining” may include considering some action as “determining”. Moreover, “determining” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
110 Radio transmission unit
120 Radio reception unit
130 NW IF unit
150 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus

1. A terminal comprising:
a reception unit that receives a temporary identifier and offset information in an initial access channel when using a second frequency band different from a first frequency band allocated for mobile communication; and
a control unit that converts the temporary identifier received by the reception unit into an identifier for communication in the second frequency band based on the offset information.

2. The terminal according to claim 1, wherein the reception unit receives downlink control information including the offset information.

3. The terminal according to claim 1, wherein the reception unit receives collision avoidance information including the offset information.

4. The terminal according to claim 1, wherein
the reception unit receives collision avoidance information taking the offset information into account, and
the control unit further determines whether the collision avoidance information takes the offset information that is predetermined or received separately into account.

5. A base station comprising:
a control unit that derives a temporary identifier, and offset information for converting the temporary identifier into an identifier for communication in a second frequency band different from a first frequency band allocated for mobile communication; and
a transmission unit that transmits the temporary identifier and the offset information when using the second frequency band.
